(19) United States
(12) Patent Application Publication
(10) Pub. No.: US 2010/0316131 A1
(43) Pub. Date: Dec. 16, 2010

(54) MACROBLOCK LEVEL NO-REFERENCE OBJECTIVE QUALITY ESTIMATION OF VIDEO

(75) Inventors: Tamer Shanableh, Sharjah (AE); Faisal Ishtiaq, Chicago, IL (US)

Correspondence Address: Motorola, Inc., 600 North US Highway 45, W4 - 39Q, Libertyville, IL, 60048-5343, US

(73) Assignee: MOTOROLA, INC., Schaumburg, IL (US)

(21) Appl. No.: 12/814,656

(22) Filed: Jun. 14, 2010

Related U.S. Application Data
(60) Provisional application No. 61/186,487, filed on Jun. 12, 2009.

(51) Int. Cl. H04N 7/24

(52) U.S. Cl. 375/240.24; 375/E07.011

(57) ABSTRACT

A no-reference estimation of video quality in streaming video is provided on a macroblock basis. Compressed video is being deployed in video in streaming and transmission applications. MB-level no-reference objective quality estimation is provided based on machine learning techniques. First the feature vectors are extracted from both the MPEG coded bitstream and the reconstructed video. Various feature extraction scenarios are proposed based on bitstream information, MB prediction error, prediction source and reconstruction intensity. The features are then modeled using both a reduced model polynomial network and a Bayes classifier. The classified features may be used as feature vector used by a client device assess the quality of received video without use of the original video as a reference.

This application claims the benefit of U.S. Provisional Application 61/186,487 filed Jun. 12, 2009, titled Macroblock Level No-Reference Objective Quality Estimation Of Compressed MPEG Video, herein incorporated by reference in its entirety.

### BACKGROUND

Automatic quality estimation of compressed visual content emerged mainly for estimating the quality of reconstructed images/video in streaming and transmission applications. There is a need in such applications to automatically monitor and estimate the quality of compressed material due to the nature of lossy coding, transmission errors and potential intermediate video transrating and transcoding.

Automatic quality estimation of compressed visual content can also be of benefit to other applications. For instance the use of compressed surveillance video as evidence in a courtroom is gaining a significant presence. Surveillance cameras are being deployed on street corners, road intersections, transportation facilities, public schools, etc. There are a number of important factors for the admissibility of compressed video as legal evidence, including the authenticity and quality of the video. The former factor might require the testimony of forensics experts to verify the authenticity of the video. Often, only the compressed video is available. The latter factor often undergoes subjective assessment by video experts.

Quality estimation of reconstructed video generally falls into two main categories; ‘Reduced Reference (RR)’ estimation and ‘No Reference (NR)’ estimation. In the former category, special information is extracted from the original images and subsequently made available for quality estimation at the end terminal. This information is usually of a precise and concise nature and varies from one solution to the other. On the other hand neither such information nor the original images are available for quality estimation of the NR category, thus rendering it a less accurate yet a more challenging task.

An example of the RR estimation is the ITU-T J.240 recommendation ITU-T Recommendation J.240, “Framework for remote monitoring of transmitted picture signal to-noise ratio using spread-spectrum and orthogonal transform,” 2004. It is recommended to extract a feature vector from the original image and send it to the end terminal to assist in quality estimation. The feature extraction is block-based and contains a whitening process based on Spread Spectrum and the Walsh-Hadamard Transformation. After which, a feature sample is selected and quantized to comprise the feature vector of the original image. This process is repeated at the end-terminal and the PSNR estimation is based on comparing the extracted feature vector against the original vector received with the coded image. Recently K. i Chono, Y.-Ch. Lin, D. Varodayan, Y. Miyamoto and B. Girod, “Reduced-reference image quality assessment using distributed source coding,” Proc. IEEE ICME, Hannover, Germany, June 2008, proposed the use of distributed source coding techniques where the encoder transmits the Slepian-Wolf syndrome of the feature vector using a LDPC encoder. The end-terminal reconstructed the side information of the received image and the Slepian-Wolf bitstream. Thus no need to transmit the original feature vector and therefore reducing the overall bit rate.

An example of what can be thought of as an intermediate solution between NR and RR quality estimation is the ITU-T J.147 recommendation, ITU-T Recommendation J.147, “Objective picture quality measurement method by use of in-service test signals,” 2002. The recommendation presents a method for inserting a barely visible watermark into the original image and determining degradation of the watermark at the end terminal. The solution can be categorized as an intermediate solution because the encoder is aware of the quality estimation and the watermark is available to the end terminal. The concept is elegant, however inserting such watermarks might result in either increasing the bit rate or degrading the coding quality. Similar work was reported in Y. Fu-zheng, W. Xin-dia. C. Yi-lin and W. Shuai, “A No-Reference Video Quality Assessment method based on Digital watermark,” Proc. 14th IEEE International Symposium on Personal, Indoor and Mobile Radio Communications, Beijing, China, September 2003 where a spatial domain binary watermark is inserted in every 4×4 block.

Work on the NR category can be further subdivided into subjective NR quality estimation and objective NR quality estimation, which is the topic of this paper. An example of the former subcategory is the work reported in Z. Wang, H. Sheikh and A. Bovik, “No-reference perceptual quality assessment of jpeg compressed images,” Proc. IEEE ICIP, Rochester, N.Y., September 2002. The subjective quality assessment is based on the estimation of blurring and blocking artifacts generated by block-based coders such as JPEG. The labeling phase of the system is based on subjective evaluation of original and reconstructed images. Features based on blockness and blurring are extracted from reconstructed images and non-linear regression is used to build the training model. A much simpler system was proposed for quality estimation of a universal multimedia access system based on blockness artifacts only O. Hillestad, R. Babu, A. Bopardikar, A. Perkis, “Video quality evaluation for UMA,” Proc. 5th International Workshop on Image Analysis for Multimedia Interactive Services (WIAMIS 2004), Lisboa, Portugal, April 2004. Specialized subjective quality assessment is also reported, for example L. Zhu and G. Wang “Image Quality Evaluation Based on No-reference Method with Visual Component Detection,” Proc. 3rd IEEE International Conference on Natural Computation, Haikou, China, August 2007 proposed a system in which subjective quality assessment is based on the quality of detected faces in the reconstructed images. Again the labeling phase consists of subjective testing. Features are extracted from the wavelet sub bands of the detected faces in addition to noise factors. Training and testing are then based on a mixtures of Gaussian and a radial basis function.

Work on the objective NR quality assessment of video on the other has not receive as much attention in the literature. Quality prediction of a whole video sequence as opposed to individual frames is reported in L. Yu-xin, K. Ragip and B. Udit, “Video classification for video quality prediction,” Journal of Zhejiang University Science A, 7(5), pp. 919-926, 2006. The feature extraction step involves extracting features from the whole sequence, hence each feature vector represents a sequence rather than a frame. The feature vector is then compared against a dataset of features belonging to sequences of different spatio-temporal activities coded at different bit rates. The comparison is achieved through K Nearest Neighbor (KNN) with a weighted Euclidian distance as a similarity measure. The elements of the sequence level feature vector are the following. The number of low pass or flat blocks in the sequences, total number of blocks that have texture and the number of blocks that have edges, the total number of blocks with zero motion vectors, the total number of blocks with low prediction error, the total number of blocks with medium prediction error and lastly the total number of blocks with high prediction error. The experimental results do not show the actual and predicted PSNR values, rather, only the correlation coefficient of two is reported. Similar experimental setup was also reported in R. Barland and A. Saadane, “A New Reference Free Approach for the Quality Assessment of MPEG Coded Videos,” Proc. 7th International Conference on Advanced Concepts for Intelligent Vision Systems, Antwerp, Belgium, September 2005.

Statistical information of DCT coefficients can also be used to estimate the PSNR of coded video frames. For instance in D. S. Turaga, C. Yingwei and J. Caviedes, “No reference PSNR estimation for compressed pictures,” Proc IEEE International Conference on Image Processing, vol. 3, pp. 61-64, June 2002 it was proposed to estimate the quantization error from the statistical properties of received DCT coefficients and use that estimated error in the computation of PSNR. The statistical properties are based on the fact that DCT coefficients obey a Laplacian probability distribution. The Lambda Laplacian distribution parameter is estimated for each DCT frequency band separately. The authors in D. S. Turaga, C. Yingwei and J. Caviedes, “No reference PSNR estimation for compressed pictures,” Proc. IEEE International Conference on Image Processing, vol. 3, pp. 61-64, June 2002 summarize their work by the following steps. For each DCT frequency band estimate the quantization step size and Lambda of the Laplacian probability distribution. Then use this information to estimate the squared quantization error for each DCT frequency band across a reconstructed frame. Lastly use the estimated error in the computation of the PSNR. The paper reported PSNR estimates of I-frames with constant quantization step size only with the assumption that the rest of the reconstructed video has similar quality.

Similar work was also reported in the literature, for example the work in A. Ichigaya, M. Kurozumi, N. Hara, Y. Nishida, and E. Nakasu, “A method of estimating coding PSNR using quantized DCT coefficients”, IEEE Transactions on Circuits and Systems for Video Technology, 16(2), pp. 251-259, February 2006 expanded the above work to I,P and B frames. Likewise, the work in T. Brandao and M. P. Queluz, “Blind PSNR estimation of video sequences using quantized DCT coefficient data,” Proc. Picture Coding Symposium, Lisbon, Portugal, November 2007 reported higher prediction accuracy of PSNR for I-frames only. This comes at computational complexity cost where iterative procedures such as the Newton-Raphson's method are required for the estimation of the distribution parameters

In general potential drawbacks of the work reported in D. S. Turaga, A. Ichigaya, and T. Brandao include the following:
1. The PSNR estimation is based on DCT coefficients of the reconstructed video without access to the bitstream hence the need to estimate the quantization step size.
2. The accuracy of the estimated probability distribution of each DCT frequency band depends on the percentage of non-zero DCT coefficients.
3. The distribution parameters of the DCT bands of the original data are required for the estimation of the quantization error. This means that this category of the PSNR estimation belongs to the ‘reduced reference’ rather than the ‘no reference’ category.

What is needed is an efficient and effect manner to accurately assess the quality of received video streams.

### SUMMARY OF INVENTION

In accordance with the principles of the invention, a method for assessing a quality level of received video signal, may comprise the steps of: labeling macroblocks of a decoded video according to a determination of quality measurement; extracting at least one feature associated with each macroblock of the decoded video; classifying feature vectors associating the at least one extracted feature with the quality measurement.

In the method, the quality measurement may include a peak signal to noise ratio measurement, and an identification of a plurality of quality classes. The feature of a macroblock may include at least one of: average macroblock border SAD; macroblock number of coding bits; macroblock quant stepsize; macroblock variance of coded prediction error or intensity; macroblock type; Magnitude of motion vector; Phase of motion vector; average macroblock motion vector border magnitude; average macroblock motion vector border phase; macroblock distance from last sync marker; macroblock sum of absolute high frequencies; macroblock sum of absolute Sobel edges; macroblock dist. from last intra macroblock; Texture mean; Texture Standard deviation; Texture Smoothness; Texture 3^{rd} moment; Texture Uniformity; Texture Entropy; or macroblock coded block pattern

The method may further comprise the step of expanding a feature vector based on the at least one extracted feature as a polynomial. In the method, a global matrix for each quality class of a plurality of quality classes is obtained. In the method, the step of classifying may include using a statistical classifier.

In accordance with the principles of the invention, an apparatus for identifying a quality level of received video signal, may comprise: a quality classifier which classifies quality levels of macroblocks of a video signal based on a quality measurement of each macroblocks of the video signal; a feature extraction unit which identifies at least one feature of each macroblock of the macroblocks of the video signal; a classifier which classifies at least one features of the macroblock with the detected quality level of the corresponding macroblocks.

In the apparatus, the quality measurement includes a peak signal to noise ratio measurement, and an identification of a plurality of quality classes. The apparatus may further comprise an expander which expands a feature vector based on the at least one extracted feature as a polynomial. In the apparatus, a global matrix for each quality class of a plurality of quality classes may be obtained. The classifier may be a statistical classifier.

In accordance with the principles of the invention, a computer readable medium may contain instructions for a computer to perform a method for identifying a quality level of received video signal, comprising the steps of: labeling macroblocks of a decoded video according to a determination of quality measurement; extracting at least one feature associated with each macroblock of the decoded video; classifying feature vectors associating the at least one extracted feature with the quality measurement.

In accordance with the principles of the invention, an apparatus for identifying a quality level of received video signal, may comprise: a decoder which decodes received video macroblocks; a feature extraction unit which identifies at least one feature of each macroblock of the macroblocks of the video signal; a classifier which identifies the macroblock as a quality level based on the at least one feature and classified feature vectors associating features with an a representation of video quality.

In the apparatus, the feature of a macroblock includes at least one of: average macroblock border SAD; macroblock number of coding bits; macroblock quant stepsize; macroblock variance of coded prediction error or intensity; macroblock type; Magnitude of motion vector; Phase of motion vector; average macroblock motion vector border magnitude; average macroblock motion vector border phase; macroblock distance from last sync marker; macroblock sum of absolute high frequencies; macroblock sum of absolute Sobel edges; macroblock dist. from last intra macroblock; Texture mean; Texture Standard deviation; Texture Smoothness; Texture 3^{rd} moment; Texture Uniformity; Texture Entropy; or macroblock coded block pattern

The apparatus may further comprising an expander which expands a feature vector based on the at least one extracted feature as a polynomial. The classifier may be a statistical classifier.

### BRIEF DESCRIPTION OF THE DRAWINGS

FIG. 1 illustrates an exemplary method in accordance with the principles of the invention.

FIG. 2 illustrates an exemplary architecture for classifying macroblock based on quality measurements in accordance with the principles of the invention.

FIG. 3 illustrates an exemplary architecture for extracting and classifying features in accordance with the principles of the invention.

FIG. 4 illustrates an exemplary architecture for determining a quality level of received video based on extracting and classifying features in accordance with the principles of the invention.

FIG. 5 illustrates an exemplary processing system which may be used in connection with the principles of the invention.

### DETAILED DESCRIPTION

For simplicity and illustrative purposes, the present invention is described by referring mainly to exemplary embodiments. In the following description, numerous specific details are set forth to provide a thorough understanding of the embodiments. However, it will be apparent to one of ordinary skill in the art that the present invention may be practiced without limitation to these specific details. In other instances, well known methods and structures have not been described in detail to avoid unnecessarily obscuring the description of the embodiments.

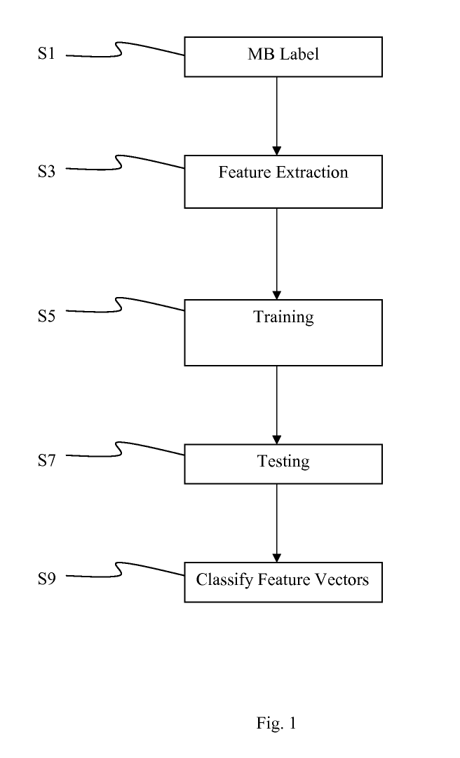

FIG. 1 illustrates an exemplary method in accordance with the principles of the invention. We apply automatic objective quality estimation to the surveillance video as an additional aid for verifying the video quality. For higher estimation accuracy we use a Macroblock (MB) level quality estimation of compressed video.

The purpose of the proposed solution is to quantify the quality of reconstructed MBs. We classify reconstructed MBs into one of five peak signal to noise ratio (PSNR) classes measured in decibels (dB). The upper and lower limits of such classes can be manipulated according to the underlying system. An example would be the following class limits:

Class 1: <25 dB

Class 2: [25-30] dB

Class 3: [30-35] dB

Class 4: [35-40] dB

Class 5: >=40 dB

A simpler classification problem would be to label MBs as ‘good quality’ or otherwise. In this case only two classes are needed to be separated by a binary threshold. For instance in video coding it is generally accepted that a PSNR quality of 35 dB and above is good. Thus the threshold can be set to 35 dB.

As illustrated in FIG. 1, to realize the MB classification, the proposed no-reference objective quality estimation system is composed of the following steps; MB labeling, feature extraction, system training or model estimation and classification or testing.

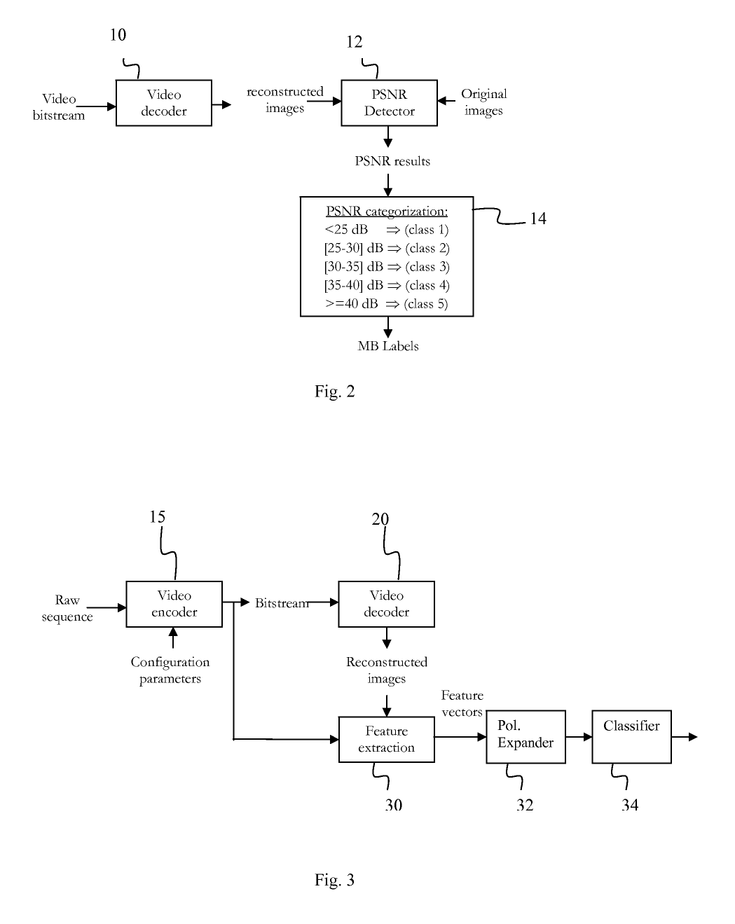

With reference to FIGS. 1 and 2, video sequences are decoded in video decoder 10 to obtain the reconstructed images. Reconstructed images may also be obtained as an output of an encoder in addition to a bitstream. The PSNR of the reconstructed images is computed for each MB of the reconstructed images at PSNR Detector 12 by comparison of the reconstructed image MBs with the original image MBs. MBs are then labeled into classes, step S1, PSNR categorization processor 14, such as one of the five classes explained earlier. Note that if binary thresholding is used then MBs will fall into one of two classes only. The labels are then used in the training phase of the system. The use of original images for PSNR calculation is available during the labeling and training phase only.

With reference to FIGS. 1 and 3, the labeling is followed by the feature extraction phase, step S3, feature extraction unit 30. The feature vectors maybe extracted from both the video bitstream and decoded video. In practice, both the bitstream and decoded video are often available for the no-reference quality estimation. In the proposed solution we utilize both of the aforementioned for feature extraction as explained below.

With reference to FIG. 1, once the features are extracted, the training phase, step S5, uses them to estimate the model parameters which will be carried on to the testing phase, step S9. Various machine learning tools can be used for this purpose, for instance polynomial networks and Bayes classifiers may be used. Lastly in the testing phase, step S7, MB level feature vectors are extracted from the bitstream and the reconstructed video of a testing sequence. The feature vectors are then classified into various classes, step S9, using the model parameter estimated from the training phase. The machine learning tools of choice and further details are presented below.

Feature Extraction

With reference to FIG. 3, as mentioned previously the features are extracted from the bitstream and reconstructed video. The choice of features is applicable to any decoder, such as an MPEG-2 decoder. The coder of choice in this work is MPEG-2. The following is a list that describes the MB level selected features:

TABLE 1
Description of selected MB features.

| Feature name | Description |
|---|---|
| 1. Avg. MB border SAD | The sum of absolute differences across MB boundaries |
| | divided by the total number of edges/MBs surrounding the |
| | current one. This is computed from the reconstructed |
| | images. |
| 2. MB number of coding bits | The number of bits needed to code a MB extracted from the |
| | bitstream. |
| 3. MB quant stepsize | The coding step size extracted from the bitstream. |
| 4. MB variance of coded | This is the variance of either the prediction error of predicted |
| prediction error or intensity | MBs or the variance of the intensity of intra MBs. |
| 5. MB type | Computer from the motion information available from the |
| | bitstream. |
| 6. Magnitude of MV | Computer from the motion information available from the |
| | bitstream. |
| 7. Phase of MV | Available from the bitstream |
| 8. Avg. MB MV border magnitude | The average difference between the magnitude of the current |
| | MV and the surrounding ones. This is computed from the |
| | motion information available from the bitstream. |
| 9. Avg. MB MV border phase. | The average difference between the phase of the current MV |
| | and the surrounding ones. This is computed from the |
| | motion information available from the bitstream. |
| 10. MB distance from last sync | The distance in MBs from the last sync marker computed |
| marker | from the bitstream. This is important because the predictors |
| | are reset at sync markers hence affecting the coding quality. |
| 11. MB sum of absolute high | The absolute sum of high DCT frequencies of a MB as an |
| frequencies | indication of quantization distortion. |
| 12. MB sum of absolute Sobel | The absolute sum of Sobel coefficients as an indication of |
| edges | edge strength. |
| 13. MB dist. from last intra MB | The distance in MBs from the last intra MB computed from |
| | the bitstream. This is important because intra MB coding |
| | might affect the number of bits allocated to successive MBs. |
| 14. Texture (mean) | Can be applied to either reconstructed MBs or prediction |
| | error. |
| 15. Texture (Standard deviation) | Can be applied to either reconstructed MBs or prediction |
| | error. |
| 16. Texture (Smoothness) | Can be applied to either reconstructed MBs or prediction |
| | error. |
| 17. Texture (3^{rd} moment) | An indication of histogram skewness. Can be applied to |
| | either reconstructed MBs or prediction error. |
| 18. Texture (Uniformity) | Can be applied to either reconstructed MBs or prediction |
| | error. |
| 19. Texture (Entropy) | Can be applied to either reconstructed MBs or prediction |
| | error. |
| 20. MB coded block pattern | Extracted from the bitstream. |

The texture's smoothness for feature index 16 in Table 1 is defined as:

sᵢ=1−1/(1+σ²) (1)

Where sᵢ is the smoothness of MB index i and σ is its texture standard deviation.

The texture's 3^{rd} moment for feature index 17 is defined as:

mᵢ=Σₙ₌₀^{N-1}(pₙ−E(p))³f(pₙ) (2)

Where mᵢ is the third moment of MB index i, N is the total number of pixels (pₙ) in a MB, E(p) is the mean pixel value and f(·) is the relative frequency of a given pixel value.

The texture's uniformity for feature index 18 is defined as:

uᵢ=Σₙ₌₀^{N-1}f²(pₙ) (3)

Where uᵢ is the uniformity of MB index i and the rest of the variables/functions are defined above.

Lastly, the texture's entropy is defined as:

eᵢ=Σₙ₌₀^{N-1}f(pₙ)log₂f(pₙ) (4)

Where eᵢ is the uniformity of MB index i and the rest of the variables/functions are defined above.

Once the MB features are extracted from both the bitstream and reconstructed video. The feature vectors are normalized to either the frame or the whole sequence. The normalization is applied to each feature separately. The normalization of choice in this work is z-scores defined as:

zᵢ=(xᵢ−E(x))/σ (5)

Where the scalars zᵢ and xᵢ are the normalized and non-normalized feature values of feature index i respectively. E(x) is the expected value of the feature variable vector and σ is its standard deviation. Both are computed based on the feature vector population.

Additionally, the above features can be generated in a number of scenarios. In the first scenario, feature 11, 12, 14-19 in Table 1 can be computed based on MB intensity available from the reconstructed video. In the second scenario the features can be based on the prediction error rather than intensity. Lastly in the third scenario, these features can be computed for both the prediction error and the source of prediction available from motion compensating reference frames. In other words, the features are also applied to the intensity of the prediction source or the best match location in reference frames. This may be important because both the prediction error and prediction source define the quality of the reconstructed MB. Thus is this scenario these features are computed twice which brings the total number of features up to 28.

Validating the Feature Variables

The choice of the above features in the three mentioned scenarios can be verified by means of stepwise regression. Notice that our classification problem can be formulated as multivariate regression in which the predictors are the feature variables and the response variable is the class label. In the stepwise regression procedure the causation of each feature variable on the response variable is tested. Feature variables that do not effectively affect the response variable are dropped out.

To illustrate the stepwise regression procedure (as described in D. Montgomery, G. Runger, “Applied statistics and probability for engineers,” Wiley, 1994), assume that we have K candidate feature variables x₁, x₂, . . . , xₖ and a single response variable y. In classification the response variable corresponds to the class label. Note that with the intercept term β₀ we end up with K+1 feature variables. In the procedure the regression model is iteratively found by adding or removing feature variables at each step. The procedure starts by building a one variable regression model using the feature variable that has the highest correlation with the response variable y. This variable will also generate the largest partial F-statistic. In the second step, the remaining K−1 variables are examined. The feature variable that generates the maximum partial F-statistic is added to the model provided that the partial F-statistic is larger than the value of the F-random variable for adding a variable to the model, such an F-random variable is referred to as fᵢₙ. Formally the partial F-statistic for the second variable is computed by:

$${f}_{2} = \frac{{SS}_{R} ( {β}_{2} \vert {β}_{1} , {β}_{0} )}{{MS}_{E} ( {x}_{2} , {x}_{1} )} .$$

Where MSE(x₂,x₁) denotes the mean square error for the model containing both x₁ and x₂. SS_{R}(β₂|β₁,β₀) is the regression sum of squares due to β₂ given that β₁,β₀ are already in the model.

In general the partial F-statistic for variable j is computed by:

$${f}_{j} = \frac{{SS}_{R} ( {β}_{j} \vert {β}_{0} , \text{?} {β}_{k} )}{{MS}_{E}} \\ \text{?} \text{indicates text missing or illegible when filed} \qquad ( 6 )$$

If feature variable x₂ is added to the model then the procedure determines whether the variable x₁ should be removed. This is determined by computing the F-statistic

$${f}_{1} = \frac{{SS}_{R} ( {β}_{1} \vert {B}_{2} , {β}_{0} )}{{MS}_{E} ( {x}_{2} , {x}_{2} )} .$$

If f₁ is less than the value of the F-random variable for removing variables from the model, such a such an F-random variable is referred to as fₒᵤₜ.

The procedure examines the remaining feature variables and stops when no other variable can be added or removed from the model. Note In this work we use a maximum P-value of 0.05 for adding variables and a minimum P-value of 0.1 for removing variables. More information on stepwise regression can be found in classical statistics and probability texts such as D. Montgomery, G. Runger, “Applied statistics and probability for engineers,” Wiley, 1994.

Table 2 and 3 show the result of running the aforementioned procedure on the feature variables of the three feature extraction scenarios.

TABLE 2
Result of running stepwise regression on features selected from MB intensities.

| | | Sequence name | | | | | | Relative |
|---|---|---|---|---|---|---|---|---|
| Source | Feature | Ailon | Hall | Pana | Traffic | Fun | Woodfield | freq |
| Intensity | 1. Avg. MB border SAD | ✓ | ✓ | ✓ | ✓ | ✓ | ✓ | 100.00 |
| | 2. MB number of coding bits | ✓ | ✓ | ✓ | ✓ | ✓ | ✓ | 100.00 |
| | 3. MB quant stepsize | ✓ | ✓ | ✓ | ✓ | ✓ | ✓ | 100.00 |
| | 4. MB variance of coded | x | ✓ | ✓ | ✓ | ✓ | ✓ | 83.33 |
| | prediction error or intensity | | | | | | | |
| | 5. MB type | ✓ | ✓ | x | ✓ | x | ✓ | 66.67 |
| | 6. Magnitude of MV | x | ✓ | ✓ | ✓ | ✓ | ✓ | 83.33 |
| | 7. Phase of MV | x | x | ✓ | ✓ | ✓ | ✓ | 66.67 |
| | 8. Avg. MB MV border magnitude | x | ✓ | ✓ | ✓ | ✓ | ✓ | 83.33 |
| | 9. Avg. MB MV border phase. | ✓ | ✓ | ✓ | ✓ | x | ✓ | 83.33 |
| | 10. MB distance from last | ✓ | ✓ | ✓ | ✓ | ✓ | ✓ | 100.00 |
| | sync marker | | | | | | | |
| | 11. MB sum of absolute high | ✓ | ✓ | ✓ | ✓ | ✓ | ✓ | 100.00 |
| | frequencies | | | | | | | |
| | 12. MB sum of absolute Sobel edges | ✓ | ✓ | ✓ | ✓ | ✓ | ✓ | 100.00 |
| | 13. MB dist. from last intra MB | x | ✓ | ✓ | ✓ | x | ✓ | 66.67 |
| | 14. Texture (mean) | ✓ | ✓ | ✓ | ✓ | ✓ | ✓ | 100.00 |
| | 15. Texture (Standard deviation) | x | x | ✓ | ✓ | ✓ | ✓ | 66.67 |
| | 16. Texture (Smoothness) | ✓ | ✓ | ✓ | ✓ | ✓ | ✓ | 100.00 |
| | 17. Texture (3^{rd} moment) | ✓ | ✓ | x | ✓ | ✓ | ✓ | 83.33 |
| | 18. Texture (Uniformity) | ✓ | ✓ | ✓ | ✓ | x | ✓ | 83.33 |
| | 19. Texture (Entropy) | ✓ | ✓ | ✓ | ✓ | ✓ | ✓ | 100.00 |
| | 20. MB coded block pattern | ✓ | ✓ | ✓ | ✓ | ✓ | x | 83.33 |

TABLE 3
Result of running stepwise regression on features selected
from MB prediction errors and prediction sources.

| | | Sequence name | | | | | | Relative |
|---|---|---|---|---|---|---|---|---|
| Source | ✓Feature | Ailon | Hall | Pana | Traffic | Fun | Woodfield | freq |
| Intensity | 1. Avg. MB border SAD | ✓ | ✓ | ✓ | ✓ | ✓ | ✓ | 100.00 |
| Prediction | 2. MB number of coding bits | ✓ | ✓ | ✓ | ✓ | ✓ | x | 83.33 |
| Error | 3. MB quant stepsize | ✓ | ✓ | ✓ | ✓ | ✓ | ✓ | 100.00 |
| | 4. MB variance of coded | x | ✓ | ✓ | ✓ | ✓ | ✓ | 83.33 |
| | prediction error or intensity | | | | | | | |
| | 5. MB type | ✓ | ✓ | ✓ | ✓ | ✓ | ✓ | 100.00 |
| | 6. Magnitude of MV | ✓ | ✓ | ✓ | ✓ | ✓ | ✓ | 100.00 |
| | 7. Phase of MV | x | x | ✓ | ✓ | ✓ | ✓ | 66.67 |
| | 8. Avg. MB MV border magnitude | ✓ | ✓ | ✓ | ✓ | ✓ | x | 83.33 |
| | 9. Avg. MB MV border phase. | x | x | x | ✓ | ✓ | ✓ | 50.00 |
| | 10. MB distance from last | ✓ | ✓ | ✓ | ✓ | ✓ | x | 83.33 |
| | sync marker | | | | | | | |
| | 11. MB sum of absolute high | x | ✓ | x | ✓ | ✓ | ✓ | 66.67 |
| | frequencies | | | | | | | |
| | 12. MB sum of absolute Sobel edges | x | x | x | ✓ | ✓ | x | 33.33 |
| | 13. MB dist. from last intra MB | x | ✓ | ✓ | ✓ | x | ✓ | 66.67 |
| | 14. Texture (mean) | x | ✓ | x | x | x | x | 16.67 |
| | 15. Texture (Standard deviation) | x | ✓ | ✓ | x | ✓ | ✓ | 66.67 |
| | 16. Texture (Smoothness) | x | ✓ | ✓ | x | ✓ | ✓ | 66.67 |
| | 17. Texture (3^{rd} moment) | x | ✓ | x | x | x | x | 16.67 |
| | 18. Texture (Uniformity) | x | x | ✓ | ✓ | ✓ | x | 50.00 |
| | 19. Texture (Entropy) | ✓ | ✓ | ✓ | ✓ | ✓ | ✓ | 100.00 |
| | 20. MB coded block pattern | x | ✓ | x | ✓ | ✓ | x | 50.00 |
| Prediction | 21. MB sum of absolute high | ✓ | ✓ | ✓ | x | ✓ | ✓ | 83.33 |
| source | frequencies | | | | | | | |
| | 22. MB sum of absolute Sobel edges | ✓ | ✓ | ✓ | ✓ | ✓ | ✓ | 100.00 |
| | 23. Texture (mean) | x | ✓ | ✓ | ✓ | ✓ | ✓ | 83.33 |
| | 24. Texture (Standard deviation) | ✓ | x | ✓ | ✓ | ✓ | ✓ | 83.33 |
| | 25. Texture (Smoothness) | ✓ | ✓ | ✓ | x | ✓ | ✓ | 83.33 |
| | 26. Texture (3^{rd} moment) | ✓ | ✓ | ✓ | ✓ | ✓ | ✓ | 100.00 |
| | 27. Texture (Uniformity) | ✓ | ✓ | ✓ | ✓ | ✓ | ✓ | 100.00 |
| | 28. texture (Entropy) | ✓ | ✓ | ✓ | ✓ | ✓ | ✓ | 100.00 |

The video sequences used, coding parameters and full experimental setup description will be given in Section 6. For the time being we will focus our attention of the results of running the stepwise procedure.

In the tables a tick sing ‘√’ indicates that the feature variable was retained by the stepwise regression procedure for that particular video sequence. A ‘x’ sign on the other hand indicates that the feature variable was dropped. The last column of each table gives the relative frequency of ‘√’s.

From the two tables it can be concluded that all feature variables were retained in at least one test sequence. This gives an indication that the selection of such variables is suitable for the classification problem at hand. The Table 3 shows that applying some of the feature variables on the prediction error is not as efficient as applying it to the source of prediction. Obvious examples are the mean and the third moment variables. This is because the reconstruction quality of a MB does not just depend on the quality of the prediction error, rather, the quality of the source of prediction is also very important. Table 3 verifies this statement by indicating a higher percentage of variable retention for features extracted from the prediction source. Therefore the third scenario of feature extraction combines both the features of the prediction error and those of the prediction source.

Training and Classification

With reference to FIG. 3 again, we use polynomial networks and Bayes classification for training and testing, respectively. However, those of skill in the art will appreciate that other suitable machine learning techniques may be used in the training and testing phases as well.

As illustrated in FIG. 3, polynomial expander 32 receives the feature vectors from feature extraction unit 30 and expands the feature vectors in a polynomial network. A polynomial network is a parameterized nonlinear map which nonlinearly expands a sequence of input vectors to a higher dimensionality and maps them to a desired output sequence. Training of a P^{th} order polynomial network consists of two main parts. The first part involves expanding the training feature vectors via polynomial expansion. The purpose of this expansion is to improve the separation of the different classes in the expanded vector space. Ideally, it is aimed to have this expansion make all classes linearly separable. The second part involves computing the weights of linear discriminant functions applied to the expanded feature vectors. The linear functions are of the following form: d(x)=w^{t}x+w₀ where w is a weight vector that determines the orientation of the linear decision hyperplane, w₀ is the bias and x is the feature vector

Polynomial networks have been used successfully in speech recognition W. Campbell, K. Assaleh, and C. Broun, “Speaker recognition with polynomial classifiers,” IEEE Transactions on Speech and Audio Processing, 10(4), pp. 205-212, 2002 and biomedical signal separation K. Assaleh, and H. Al-Nashash, “A Novel Technique for the Extraction of Fetal ECG Using Polynomial Networks,” IEEE Transactions on Biomedical Engineering, 52(6), pp. 1148-1152, June 2005.

5.1.1 Polynomial Expansion

Polynomial expansion of an M-dimensional feature vector x=[x₁ x₂ . . . x_{M}] is achieved by combining the vector elements with multipliers to form a set of basis functions, p(x). The elements of p(x) are the monomials of the form

$${\prod }_{j = 1}^{M} {x}_{j}^{{k}_{j}} ,$$

where kⱼ is a positive integer, and

$$0 \leq {\sum }_{j = 1}^{M} {k}_{j} \leq P .$$

Therefore, the P^{th} order polynomial expansion of an M-dimensional vector x generates an O_{M,P} dimensional vector p(x). O_{M,P} is a function of both M and P and can be expressed as

$${O}_{M , P} = 1 + PM + {\sum }_{l = 2}^{P} C ( M , l ) \qquad ( 7 )$$

where

$$C ( M , l ) = ( \begin{matrix}M \\ l\end{matrix} )$$

is the number of distinct subsets of l elements that can be made out of a set of M elements. Therefore, for class i the sequence of feature vectors Xᵢ=[x_{i,1} x_{i,2} . . . , x_{i,N}_{ᵢ}]^{T} is expanded into

Vᵢ=[p(x_{i,1})p(x_{i,2}) . . . p(x_{i,N}_{ᵢ})]^{T} (8)

Notice that while xᵢ is a Nᵢ×M matrix, vᵢ is a Nᵢ×O_{M,p} matrix.

Expanding all the training feature vectors results in a global matrix for all K classes obtained by concatenating all the individual Vᵢ matrices such that v=[v₁ v₂ . . . v_{K}]^{T}.

Reduced Polynomial Model

To reduce the dimensionality involved in feature vector expansion and yet retain the classification power, the work in K.-A Toh, Q.-L. Tran and D. Srinivasan, “Benchmarking a Reduced Multivariate Polynomial Pattern Classifier,” IEEE Transactions on pattern analysis and machine intelligence, 26(6), JUNE 2004 proposed the use of multinomial for expansion and model estimation. The weight parameters are estimated from the following multinomial model:

$${f}_{RM} ( α , x ) = {α}_{0} + {\sum }_{k = 1}^{r} {\sum }_{j = 1}^{l} {α}_{kj} {x}_{j}^{k} + {\sum }_{j = 1}^{r} {{α}_{rl + j} ( {x}_{1} + {x}_{2} + … + {x}_{l} )}^{j} + {\sum }_{j = 2}^{r} ( {α}_{j}^{T} , x ) \cdot {( {x}_{1} + {x}_{2} + … + {x}_{l} )}^{j - 1} , l , r \geq 2 \qquad ( 9 )$$

Where r is the order of the polynomial, α is the polynomial weights to be estimated, x is the feature vector containing l inputs and k is the total number of terms in f_{RM}(α,xⱼ. Just like the case of classical polynomial networks, the polynomial weights are estimated using least-squares error minimization.

Note that the number of terms in this model is a function of l and r, thus the dimensionality of the expanded feature vector can be expressed by k=1+r+1(2r−1). As such the expansion of feature vectors in this work will follow this expansion model.

The polynomial expansion results may be provided to a classifier 34 where the results are associated with a quality classification, such as the PSNR classification of class 1 through class 5 discussed above.

An alternative training approach may be to use the Bayes classifier which is a statistical classifier that has a decision function of the form:

dᵢ(x)=p(x|ωⱼ)P(ωⱼ) j=1, 2, . . . , K (10)

Where p(x|ωⱼ) is the PDF of the of the feature vector population of class ωⱼ. K is the total number of classification classes and P(ωⱼ) is the probability of occurrence for class ωⱼ.

When the PDF is assumed to be Gaussian, the decision function can be written as:

$${d}_{j} ( x ) = ln P ( {ω}_{j} ) - \frac{1}{2} ln \vert {C}_{j} \vert - \frac{1}{2} [ {( x - {m}_{j} )}^{T} {C}_{j}^{- 1} ( x - {m}_{j} ) ] \\ j = 1 , 2 , … , K \qquad ( 11 )$$

Where Cⱼ and mⱼ are the covariance matrix and mean vector of the feature vector population x of class ωⱼ.

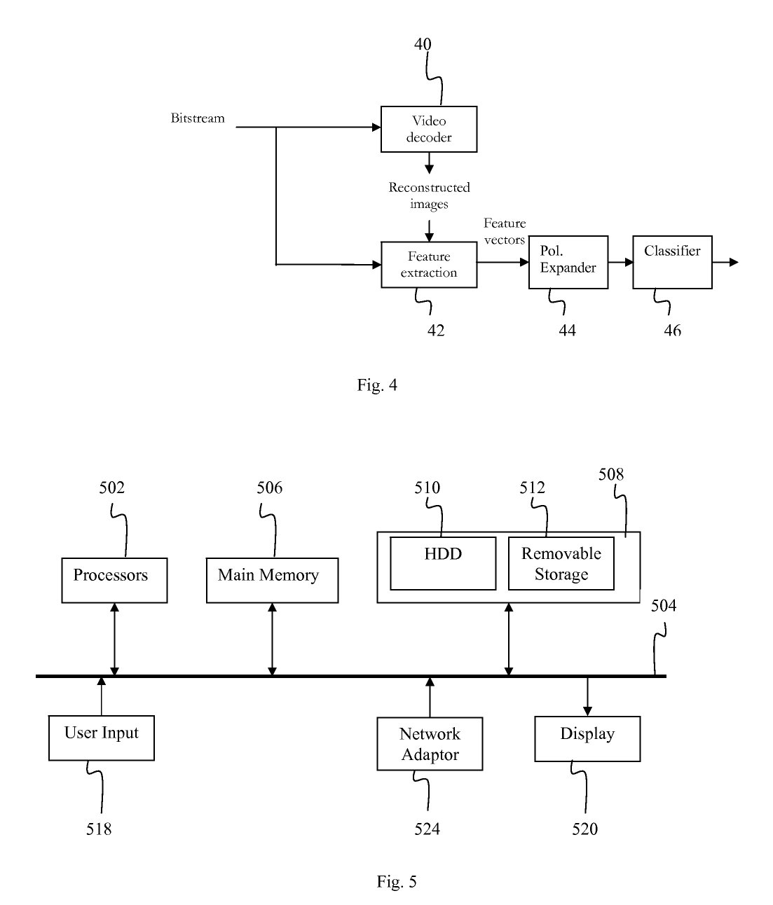

FIG. 4 illustrates an exemplary client side architecture, which may be included in any device which receives a video signal to be tested, such as a set top box, portable video device (i.e. a police or emergency crew video feed, security video feed, etc.) As illustrated, video decoder 40 receives an encoded video stream from a remote source and forms a reconstructed image. The feature extraction unit 42 receives the classified feature vectors from the remote source, or another source and extracts the selected features from the reconstructed images on a MB basis. The extracted feature vectors may undergo polynomial expansion in expander 44 and applied to classifier 46. Classifier 46 classifies the MBs of the reconstructed in accordance with the quality classification used, such as class 1 through 5 of the PSNR classification discussed earlier. In this manner, the client device is able to accurately classify the quality of the video received without use of the original video.

Those of skill in the art will appreciate that the classification of the quality of MBs at the client side may be used for a variety of purposes. For example, a report may be provided to a service provider to accurately indicate or verify if a quality of service is provided to a customer. The indication of quality may also be used to confirm that video used as evidence in a trial is of a sufficient level of quality to be relied upon. It should also be noted that the MB labeling and training of the model parameters can be done on a device separate from where the no-reference classification and assessment will happen. In this scenario model parameters, and any updates to them, can be sent to the client device as desired.

In exemplary simulated implementations, the classification rates of may be presented in two main categories; sequence dependent and sequence independent classification. Furthermore the section presents the results of classifying reconstructed MBs into both 5 and 2 classes.

In the simulated implementation described below, the video sequence of choice are all of a surveillance nature. The sequences are in CIF format with 250 frames (one exception is the Ailon sequence with 160 frames). the name of the sequences are: Ailon, Hall Monitor, Pana, Traffic, Funfair and Woodfield.

The sequences are MPEG-2 coded with an average PSNR around 30 dB. The group of picture structure is N=100 and M=1, that is, every 100^{th} frame is intra coded. Prior to presenting the classification results it is important to show the distribution of the MB labels across either the 5 or 2 classes proposed in this work.

TABLE 4
Relative frequency distribution of MB labels across 2 classes.

| Sequence | Percentage of | Percentage of |
|---|---|---|
| name | Class 1 | Class 2 |
| Ailon | 55.55% | 44.44% |
| Hall | 41.05% | 58.94% |
| Pana | 65.79% | 34.20% |
| Traffic | 25.91% | 74.08% |
| Fun | 81.09% | 18.90% |
| Woodfield | 32.42% | 67.57% |

TABLE 5
Relative frequency distribution of MB labels across 5 classes.

| Sequence | Class 1 | Class 2 | Class 3 | Class 4 | Class 5 |
|---|---|---|---|---|---|
| name | (<25 dB) | ([25-30[ dB) | ([30-35[ dB) | ([35-40[ dB) | (>=40 dB) |
| Ailon | 0.16% | 11.49% | 43.9% | 30.6% | 13.78% |
| Hall | 5.69% | 14.32% | 21.05% | 39.35% | 19.6% |
| Pana | 0% | 18.68% | 47.12% | 25.73% | 8.47% |
| Traffic | 0.78% | 8.14% | 16.99% | 20.2% | 53.84% |
| Fun | 3.45% | 30.5% | 47.15% | 17.17% | 1.72% |
| Woodfield | 0.211% | 13.1% | 19.11% | 21.7% | 45.87% |

Tables 4 and 5 show that the MB labels are reasonability distributed among the classification classes. This is expected to simulate a real life scenario where a uniform distribution is far from reality.

All the classification results presented in this section are either generated by the reduced model polynomial networks (referred to as polynomial network or polynomial classifier for short) or the Bayes classifier as described in Section 5.

In another embodiment, the training may be based on a sequence dependent classification. Here the training phase is based on MB feature vectors coming from the same source of the testing sequence. In terms of experimental simulation, the feature vectors of a video sequence is split into 50% for training and 50% for testing. It is important to notice that the testing feature vectors are unseen by the training model. This simulates a real life scenario in which the training feature vectors can be acquired from the same surveillance source at a different time.

Table 6 presents the classification results using 5 PSNR classes. The table shows that the second order expansion of feature vectors followed by linear classification results in an average classification rate of 78%. The table also shows that applying the feature extraction to the reconstructed MBs results in higher classification accuracy than applying it to the prediction error. Again, this is so because the prediction error does not fully describe the PSNR quality of a MB.

On the other hand, the results obtained from the Bayes classifier are less accurate than these produced by the reduced model polynomial classifier. This is because the latter classifier does not make any assumptions about the Gaussianity of the distribution of the feature vector population.

TABLE 6
Sequence dependent classification results using 5 PSNR classes.
Features extracted from MB prediction error versus reconstructed
MBs.

| | 2^{nd} order | | Bayes | |
|---|---|---|---|---|
| | polynomial classifier | | classifier | |
| | Features | Features of | Features | Features of |
| Sequence | of recon | prediction | of recon | prediction |
| name | images | error | images | error |
| Ailon | 79.20% | 65.16% | 68.7% | 48.91% |
| Hall | 68.94% | 58.22% | 60% | 43.92% |
| Pana | 84.77% | 80.53% | 79.9% | 80.55% |
| Traffic | 74.56% | 72.88% | 71.3% | 66.87% |
| Fun | 78.96% | 76.24% | 77.8% | 73.19% |
| Woodfield | 82.32% | 75.47% | 78.2% | 67.17% |
| Average | 78.13% | 71.42% | 72.65% | 63.4% |

As mentioned in Section 3, the third feature extraction scenario involves both the MB prediction error and prediction source. Table 7 presents the classification results obtained from this scenario. Comparing the classification results of the 2^{nd} order expansion with those of Table 6, it is clear that this scenario exhibits slightly a higher classification accuracy. Bear in mind that we now have 28 features instead of 20. Thus more information is available about a MB including it prediction error and prediction source available from the reference frame. This was not the case for the Bayes classifier however. It seems that increasing the dimensionality to 28 elements reduced the Gaussianity of the features further. Note that the 3^{rd} and 4^{th} order feature vector expansion are presented for the purpose of comparison with Table 8.

TABLE 7
Sequence dependent classification results using 5 PSNR classes.
Features extracted from MB prediction error and prediction source.

| | Features of prediction error and motion compensated | | | |
|---|---|---|---|---|
| | prediction source | | | |
| Sequence | 2^{nd} order | 3^{rd} order | 4^{th} order | Bayes |
| name | polynomial | polynomial | polynomial | classifier |
| Ailon | 79.77% | 79.885 | 79.45% | 69.65% |
| Hall | 69.76% | 72.11% | 67.93% | 50.67% |
| Pana | 85.05% | 87.09% | 87.62% | 80.12% |
| Traffic | 74.74% | 76.64% | 77.35% | 71.47% |
| Fun | 78.73% | 80.44% | 81.05% | 75.49% |
| Woodfield | 82.51% | 83.54% | 82.47% | 75.52% |
| Average | 78.43% | 79.95% | 79.31% | 70.48% |

In Table 8, the features are based on reconstructed MBs. The table presents the classification results based on segregating the training and testing based on MB type. The total number of features of inter MBs is 20 while that of intra MBs is 15. This is because the latter MBs have no motion information. Comparing the classification results of the inter MBs with Tables 6 and 7, it is clear that the segregate modeling and classification is advantageous to such MBs. However the classification accuracy of intra MBs is less accurate when compared to the results of Tables 6 and 7. This can be justified by that the fact that intra MBs have no motion information hence less feature variables leading to lower classification accuracy. In conclusion, since the percentage of predicted MBs in a coded video is typically much higher than that of intra MBs, it is advantageous to segregate the modeling and classification of the two types.

TABLE 8
Sequence dependent classification results with segregated
modeling and classification for intra and inter MBs.

| | Inter MBs | | | Intra MBs | | |
|---|---|---|---|---|---|---|
| Sequence | 2^{nd} Order | 3^{rd} Order | 4^{th} Order | 2^{nd} Order | 3^{rd} Order | 4^{th} Order |
| name | expansion | expansion | expansion | expansion | expansion | expansion |
| Ailon | 80.18% | 81.65% | 81.24% | 71.70% | 69.06% | 68.59% |
| Hall | 75.04% | 77.20% | 78.23% | 60.62% | 63.50% | 64.63% |
| Pana | 86.08% | 87.78% | 88.40% | 80.32% | 83.00% | 82.06% |
| Traffic | 75.29% | 77.55% | 78.17% | 75.99% | 77.92% | 78.67% |
| Fun | 79.27% | 80.81% | 81.81% | 77.78% | 78.22% | 79.30% |
| Woodfield | 83.96% | 85.53% | 85.82% | 70.18% | 72.40% | 72.53% |
| Average | 79.97% | 81.75% | 82.28% | 72.77% | 74.02% | 74.29% |

Features extracted from reconstructed MBs.

The same experiment presented in Table 6 in repeated in Table 9 using two classification classes. The Threshold was set to 35 dB as mentioned previously. The conclusions are consistent with those of Table 6. One additional comment here is the higher accuracy of classification incurred by reducing the number of classification classes. Clearly a binary classification problem is easier and results in higher accuracy as evident by the 93.76% average classification rate.

TABLE 9
Sequence dependent classification results using 2 PSNR classes.
Features extracted from MB prediction error versus reconstructed
MBs.

| | 2^{nd} order | | Bayes | |
|---|---|---|---|---|
| | polynomial classifier | | classification | |
| | Features | Features of | Features of | Features of |
| Sequence | of recon | prediction | recon | Prediction |
| name | images | error | images | error |
| Ailon | 91.96% | 90.63% | 73.22% | 81.05% |
| Hall | 92.94% | 88.69% | 88.15% | 84.04% |
| Pana | 96.45% | 94.88% | 88.38% | 91.37% |
| Traffic | 93.20% | 92.52% | 89.42% | 83.69% |
| Fun | 93.36% | 91.99% | 91.04% | 86.96% |
| Woodfield | 94.60% | 94.67% | 90.12% | 86.48% |
| Average | 93.76% | 92.23% | 86.72% | 85.59% |

The experiment is repeated with the feature extraction applied to both the MB prediction error and prediction source. Comparing the results of the second order expansion, the classification results presented in Table 10 exhibits higher classification rates. Again the conclusion is that such a feature extraction scenario has higher accuracy since more information is available to the model estimation in the training phase.

TABLE 10
Sequence dependent classification results using 5 PSNR classes.
Features extracted from MB prediction error and prediction source.

| | Features of prediction error and motion compensated | | | |
|---|---|---|---|---|
| | prediction source | | | |
| Sequence | 2^{nd} order | 3^{rd} order | 4^{th} order | Bayes |
| name | polynomial | polynomial | polynomial | classifier |
| Ailon | 92.14% | 91.69% | 91.33% | 74.89% |
| Hall | 93.74% | 94.40% | 92.35% | 86.39% |
| Pana | 96.62% | 96.92% | 96.83% | 88.23% |
| Traffic | 93.40% | 94.17% | 94.88% | 87.77% |
| Fun | 92.95% | 93.73% | 93.90% | 90.80% |
| Woodfield | 94.58% | 94.67% | 93.94% | 89.38% |
| Average | 93.91% | 94.26% | 93.87% | 86.24% |

In sequence independent classification, the training feature vectors come are obtained from sequences different than the testing sequence. This is analogous to user dependent and user independent speech recognition. Clearly sequence independent classification is a more challenging problem than sequence dependent. Therefore in this section we focus on sequence independent classification into 2 PSNR classes only.

The training in the following results is based on feature vectors extracted from 5 video sequences. The sixth sequence is left out for testing. For procedure is repeated for all video sequences.

Table 11 presents the classification results using features from reconstructed MBs and prediction errors. It is interesting to see that the 1^{st} order polynomial classification which is basically a linear classifier results in encouraging classification results. This was not the case for sequence dependent classification hence not presented in the previous sub-section. Among the four results presented, the features extracted from the reconstructed MBs exhibits the highest classification results of 87.32%.

TABLE 11
Sequence independent classification results using 2 PSNR classes.
Features extracted from MB prediction error versus reconstructed
MBs.

| | 1^{st} order | | 2^{nd} order | |
|---|---|---|---|---|
| | polynomial classifier | | polynomial classifier | |
| Sequence | Features of | Features of | Features of | Features of |
| name | recon images | prediction error | recon images | prediction error |
| Ailon | 74.90% | 62.82% | 78.72% | 62.86% |
| Hall | 90.17% | 88.99% | 84.65% | 73.86% |
| Pana | 89.11% | 86.01% | 88.57% | 82.58% |
| Traffic | 91.96% | 87.18% | 86.47% | 68.98% |
| Fun | 89.13% | 81.60% | 73.52% | 70.89% |
| Woodfield | 89.13% | 81.60% | 73.52% | 70.89% |
| Average | 87.32% | 81.82% | 80.91% | 73.51% |

For completeness the experiment is repeated whilst extracting the feature vectors from the MB prediction error and prediction source. Again the classification results are higher due to the availability of more information on both the prediction error and prediction source as mentioned previously. This conclusion is consistent with the sequence dependent testing presented in the previous sub-section.

TABLE 12
Sequence independent classification results using 2 PSNR classes.
Features extracted from MB prediction and prediction source.

Features of prediction
error and motion
compensated
prediction source

| Sequence | 1^{st} order | 2^{nd} order |
|---|---|---|
| name | polynomial | polynomial |
| Ailon | 79.74% | 79.03% |
| Hall | 91.25% | 87.26% |
| Pana | 88.97% | 87.95% |
| Traffic | 91.70% | 88.03% |
| Fun | 87.90% | 76.46% |
| Woodfield | 87.90% | 76.46% |
| Average | 87.89% | 84.29% |

Some or all of the operations set forth in the figures may be contained as a utility, program, or subprogram, in any desired computer readable storage medium. In addition, the operations may be embodied by computer programs, which can exist in a variety of forms both active and inactive. For example, they may exist as software program(s) comprised of program instructions in source code, object code, executable code or other formats. Any of the above may be embodied on a computer readable storage medium, which include storage devices.

Exemplary computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

FIG. 5 illustrates a block diagram of a computing apparatus 500 configured to implement or execute one or more of the processes depicted in FIGS. 3 and 4, according to an embodiment. It should be understood that the illustration of the computing apparatus 500 is a generalized illustration and that the computing apparatus 500 may include additional components and that some of the components described may be removed and/or modified without departing from a scope of the computing apparatus 500.

The computing apparatus 500 includes a main processor 502 that may implement or execute some or all of the steps described in one or more of the processes depicted in FIG. 1. For example, the processor 502 may be configured to implement one or more programs stored in the memory 508 to classify feature vectors as described above.

Commands and data from the processor 502 are communicated over a communication bus 504. The computing apparatus 500 also includes a main memory 506, such as a random access memory (RAM), where the program code for the processor 502 may be executed during runtime, and a secondary memory 508. The secondary memory 508 includes, for example, one or more hard disk drives 510 and/or a removable storage drive 512, representing a floppy diskette drive, a magnetic tape drive, a compact disk drive, etc.

User input 518 devices may include a keyboard, a mouse, and a touch screen display. A display 520 may receive display data from the processor 502 and convert the display data into display commands for the display 520. In addition, the processor(s) 502 may communicate over a network, for instance, the Internet, LAN, etc., through a network adaptor 524.

In accordance with the principles of the invention, a machine learning approach to MB-level no-reference objective quality assessment may be used. MB features may be extracted from both the bitstream and reconstructed video. The feature extraction is applicable to any MPEG video coders. Three feature extraction scenarios are proposed depending on the source of feature vectors. Model estimation based on the extracted feature vectors is based on a reduced model polynomial expansion with linear classification. A Bayes classier may also be used. It was shown that the extracted features are better modeled using the former classifier since no assumptions are made regarding the distribution of the feature vector population. The experimental results also revealed that segregating the training and testing based on MB type is advantageous to predicted MBs. A second order expansion results in encouraging classification results using either 5 or 2 PSNR classes. Lastly, sequence independent classification is also possible using 2 PSNR classes. The experimental results showed that a linear classifier suffices in this case.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims—and their equivalents—in which all terms are mean in their broadest reasonable sense unless otherwise indicated.

We claim:

1. A method for assessing a quality level of received video signal, comprising the steps of:
labeling individual macroblocks of a decoded video according to a determination of quality measurement;
extracting at least one feature associated with each macroblock of the decoded video;
classifying feature vectors associating the at least one extracted feature with the quality measurement.

2. The method of claim 1, wherein the quality measurement includes a peak signal to noise ratio measurement, and an identification of a plurality of quality classes.

3. The method of claim 1, wherein the feature of a macroblock includes at least one of: average macroblock border SAD; macroblock number of coding bits; macroblock quant stepsize; macroblock variance of coded prediction error or intensity; macroblock type; Magnitude of motion vector; Phase of motion vector; average macroblock motion vector border magnitude; average macroblock motion vector border phase; macroblock distance from last sync marker; macroblock sum of absolute high frequencies; macroblock sum of absolute Sobel edges; macroblock dist. from last intra macroblock; Texture mean; Texture Standard deviation; Texture Smoothness; Texture 3^{rd} moment; Texture Uniformity; Texture Entropy; or macroblock coded block pattern

4. The method of claim 1, further comprising the step of expanding a feature vector based on the at least one extracted feature as a polynomial.

5. The method of claim 4, wherein a global matrix for each quality class of a plurality of quality classes is obtained.

6. The method of claim 1, wherein the step of classifying includes using a statistical classifier.

7. An apparatus for assessing a quality level of received video signal, comprising:
a quality classifier which classifies quality levels of macroblocks of a video signal based on a quality measurement of each macroblocks of the video signal;
a feature extraction unit which identifies at least one feature of each macroblock of the macroblocks of the video signal;
a classifier which classifies the at least one features of the macroblock with the detected quality level of the corresponding macroblocks.

8. The apparatus of claim 7, wherein the quality measurement includes a peak signal to noise ratio measurement, and an identification of a plurality of quality classes.

9. The apparatus of claim 7, wherein the feature of a macroblock includes at least one of average macroblock border SAD; macroblock number of coding bits; macroblock quant stepsize; macroblock variance of coded prediction error or intensity; macroblock type; Magnitude of motion vector; Phase of motion vector; average macroblock motion vector border magnitude; average macroblock motion vector border phase; macroblock distance from last sync marker; macroblock sum of absolute high frequencies; macroblock sum of absolute Sobel edges; macroblock dist. from last intra macroblock; Texture mean; Texture Standard deviation; Texture Smoothness; Texture 3^{rd} moment; Texture Uniformity; Texture Entropy; or macroblock coded block pattern

10. The apparatus of claim 7, further comprising an expander which expands a feature vector based on the at least one extracted feature as a polynomial.

11. The apparatus of claim 10, wherein a global matrix for each quality class of a plurality of quality classes is obtained.

12. The apparatus of claim 7, wherein the classifier is a statistical classifier.

13. A computer readable medium containing instructions for a computer to perform a method for identifying a quality level of received video signal, comprising the steps of:
labeling macroblocks of a decoded video according to a determination of quality measurement;
extracting at least one feature associated with each macroblock of the decoded video;
classifying feature vectors associating the at least one extracted feature with the quality measurement.

14. The computer readable medium of claim 13, wherein the quality measurement includes a peak signal to noise ratio measurement, and an identification of a plurality of quality classes.

15. The computer readable medium of claim 13, wherein the feature of a macroblock includes at least one of: average macroblock border SAD; macroblock number of coding bits; macroblock quant stepsize; macroblock variance of coded prediction error or intensity; macroblock type; Magnitude of motion vector; Phase of motion vector; average macroblock motion vector border magnitude; average macroblock motion vector border phase; macroblock distance from last sync marker; macroblock sum of absolute high frequencies; macroblock sum of absolute Sobel edges; macroblock dist. from last intra macroblock; Texture mean; Texture Standard deviation; Texture Smoothness; Texture 3^{rd} moment; Texture Uniformity; Texture Entropy; or macroblock coded block pattern

16. The computer readable medium of claim 13, further comprising the step of expanding a feature vector based on the at least one extracted feature as a polynomial.

17. The computer readable medium of claim 16, wherein a global matrix for each quality class of a plurality of quality classes is obtained.

18. The computer readable medium of claim 13, wherein the step of classifying includes using a statistical classifier.

19. An apparatus for identifying a quality level of received video signal, comprising:
a decoder which decodes received video macroblocks;
a feature extraction unit which identifies at least one feature of each macroblock of the macroblocks of the video signal;
a classifier which identifies the macroblock as a quality level based on the at least one feature and classified feature vectors associating features with an a representation of video quality.

20. The apparatus of claim 19, wherein the feature of a macroblock includes at least one of: average macroblock border SAD; macroblock number of coding bits; macroblock quant stepsize; macroblock variance of coded prediction error or intensity; macroblock type; Magnitude of motion vector; Phase of motion vector; average macroblock motion vector border magnitude; average macroblock motion vector border phase; macroblock distance from last sync market; macroblock sum of absolute high frequencies; macroblock sum of absolute Sobel edges; macroblock dist. from last intra macroblock; Texture mean; Texture Standard deviation; Texture Smoothness; Texture 3^{rd} moment; Texture Uniformity; Texture Entropy; or macroblock coded block pattern

21. The apparatus of claim 19, further comprising an expander which expands a feature vector based on the at least one extracted feature as a polynomial.

22. The apparatus of claim 19, wherein the classifier is a statistical classifier.
